(19) United States
(12) Patent Application Publication
(10) Pub. No.: US 2006/0195781 A1
(43) Pub. Date: Aug. 31, 2006

(54) Integrating computer applications using groupware products

(76) Inventors: Jayanthan Jatavallabha, Karnataka (IN); Venkat Srinivas Seshasai, Chennai (IN)

Correspondence Address: FISH & RICHARDSON, P.C., PO BOX 1022, MINNEAPOLIS, MN, 55440-1022, US

(21) Appl. No.: 11/065,547

(22) Filed: Feb. 25, 2005

(51) Int. Cl. G06F 17/00

(52) U.S. Cl. 715/506; 715/505

(57) ABSTRACT

Techniques are described to enable a user to define an interactive form template that includes application attributes that are included in the processing computer application and are not otherwise included in the groupware application. At runtime, an instance of the interactive form is populated with attribute values from the processing computer application that correspond to the application attributes defined in the interactive form. The instance of the interactive form is sent to the groupware application as an attachment to a groupware data item. A person using the groupware application then may view additional attribute values from the processing computer application that are included in the interactive form and are not otherwise included in the groupware application.

### TECHNICAL FIELD

This description relates to techniques for the customization of computer systems.

### BACKGROUND

Enterprise information technology (IT) systems often are used to manage and process business data. To do so, a business enterprise may use various application programs running on one or more enterprise IT systems. Application programs may be used to process business transactions, such as taking and fulfilling customer orders, providing supply chain and inventory management, performing human resource management functions, and performing financial management functions. Application programs also may be used for analyzing data, including analyzing data obtained through transaction processing systems. In many cases, application programs used by a business enterprise are developed by a commercial software developer for sale to, and use by, many business enterprises. Another type of application program is a groupware application that includes information about contacts (such as an address book), information about tasks or activities to be accomplished, and/or a calendar of appointments. A groupware application may be used by an individual or by a group of people.

### SUMMARY

Generally, the described techniques enable the integration of transaction processing computer applications with commercially available groupware application products, such as Microsoft Exchange available from Microsoft Corporation of Redmond, Wash. or Lotus Domino available from IBM Corporation of White Plains, N.Y. Techniques enable a user, such as a business analyst or a system administrator, to define an interactive form template that includes application attributes that are included in the processing computer application and are not otherwise included in the groupware application product.

At runtime, when groupware data is to be sent from the processing computer application to the groupware product, an interactive form is generated from the interactive form template and the instance of the interactive form is populated with attribute values from the processing computer application that correspond to the application attributes defined in the interactive form. The generated interactive form may be referred to as an instance of the interactive form or an instance of the interactive form template. The instance of the interactive form is sent to the groupware application as an attachment to a groupware data item that includes attribute values that are included in the groupware product. For example, the interactive form may be sent to the groupware application as an attachment to groupware data that is included in the standard groupware application. The groupware data may be formatted according to a standard data format, such as the iCalendar or vCard standards specified by the Internet Engineering Task Force (IETF). For example, the groupware data may be information about a business partner that is formatted for transport as a groupware contact (such as vCard) and the instance of the interactive form may be an attachment to the vCard data. Similarly, the groupware data may be information about an appointment that is formatted for transport as a groupware calendar item (such as iCalendar) and the instance of the interactive form may be an attachment to the iCalendar data.

The groupware application product receives and stores the groupware information, including the attached interactive form. A person using the groupware product then may view and edit the additional attribute values from the processing computer application that are included in the interactive form. In this manner, attribute values from the processing computer application are made available in a groupware product that are not otherwise included in the groupware application product.

In one general aspect, data is provided to a groupware computer application. To do so, an instance of an interactive form is generated that corresponds to an interactive form template. A form field of the instance of the interactive form includes an attribute value included in a computer processing application. The instance of the interactive form is attached to a groupware data item to be provided to groupware computer application. The groupware data item includes data created or revised by the computer processing application. The groupware data item and the attached instance of the interactive form is provided to the groupware computer application.

Implementations may include one or more of the following features. For example, the interactive form template may be identified based on groupware data to be provided by the computer processing application to the groupware computer application. In some implementations, the interactive form template may be identified based on a type of data included in the groupware data to be provided by the computer processing application to the groupware computer application. The groupware data item and the attachment may be transmitted to the groupware computer application.

Mapping information associated with the interactive form template may be used to create the instance of the interactive form. The mapping information may associate a form field with an attribute included in the computer processing application. The interactive form template may include the mapping information, or the mapping information may be accessed separately from the interactive form template.

A person may be able to use the groupware computer application to view the attached instance of the interactive form. Groupware data received from the computer processing application may be transformed to a format commonly used for groupware data, and groupware data in the format commonly used for groupware data may be transformed to a format used by the groupware computer application.

The groupware computer application may be a commercial groupware computer application developed for use by multiple business enterprises. The computer processing application may be a transaction processing computer application or an analytical computer application.

Implementations of any the techniques discussed above may include a method or process, a system or apparatus, or computer software on a computer-accessible medium. The details of one or more implementations of the invention are set forth in the accompanying drawings and the description below. Other features, objects, and advantages of the invention will be apparent from the description and drawings, and from the claims.

### DESCRIPTION OF DRAWINGS

FIGS. 1 and 2 are block diagrams of systems incorporating various aspects of the invention.

FIG. 3 is a flow chart of a process for defining an interactive form and mapping attributes included in the interactive form to attributes included in a computer processing application.

FIG. 4 is a flow chart of a process for creating an attachment based on an interactive form.

FIG. 5 is a flow chart of a process for receiving and enabling a user to access a groupware data item and an interactive form attachment.

FIG. 6 is a flow chart of a process updating attributes values of the computer processing application based on attribute values changes made to an instance of an interactive form.

Like reference symbols in the various drawings indicate like elements.

### DETAILED DESCRIPTION

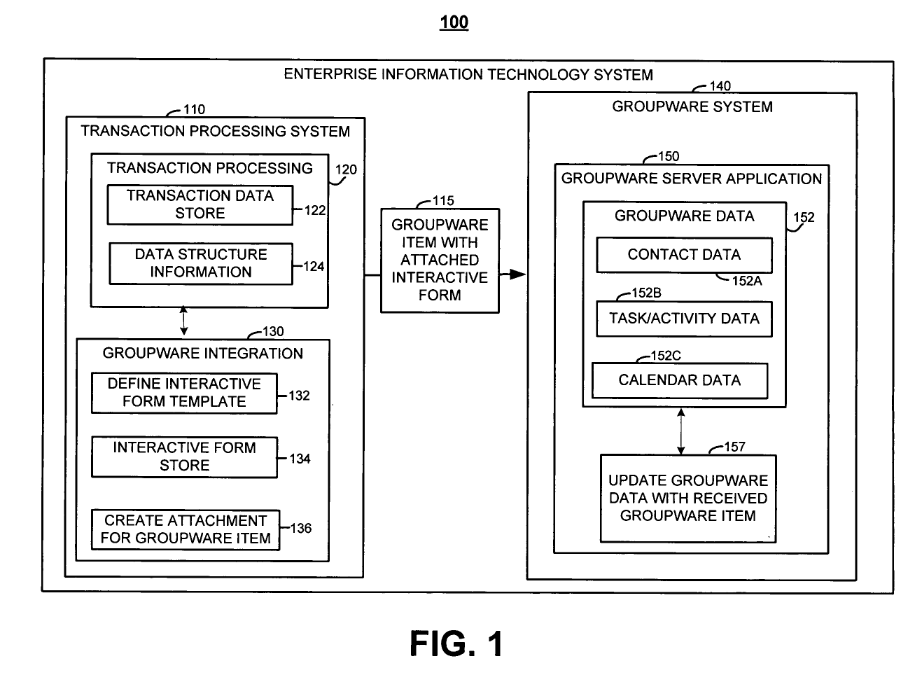

An enterprise information technology (IT) system 100, shown in FIG. 1, integrates groupware data 152 created in a transaction processing system 110 with groupware data of a groupware system 140 in accordance with the invention. In general, a groupware data item 115, such as a calendar data item, a contact data item, or a task or activity data item, is transferred from the transaction processing system 110 to the groupware system 140. An interactive form with attribute values that are included in the transaction processing system 110 and not otherwise included in the groupware system 140 is attached to the groupware data item 115 and transmitted with the groupware data item 115 to the groupware system 140. A user of the groupware server application 150 operating on the groupware system 140 is able to use the groupware system 140 to view the interactive form 115 attached to the groupware data item 115 and, in so doing, view attribute values that are otherwise not available in the groupware server application 150.

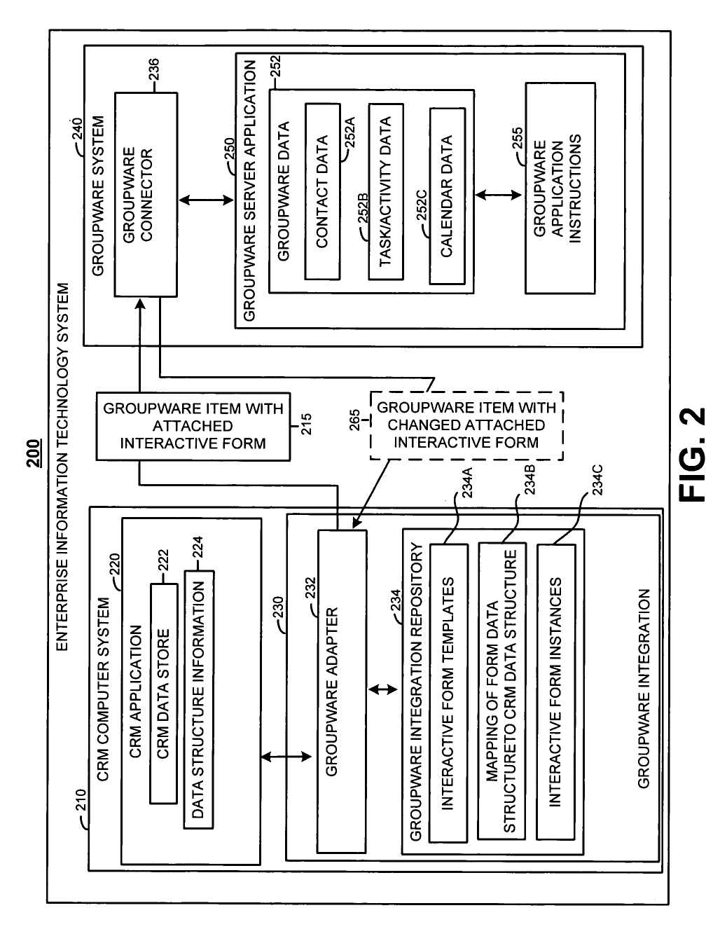

More particularly, the system 100 includes the transaction processing system 110 and the groupware system 140, each of which is capable of executing instructions on data and are interconnected. Communication between the transaction processing system 110 and the groupware system 140 may be provided, for example, through a variety of established networks, such as, for example, the Internet, a Public Switched Telephone Network (PSTN), the Worldwide Web (WWW), a wide-area network (“WAN”), a local area network (“LAN”), a wired network, or a wireless network. The communication also may be provided through the use of a middleware messaging system, as described more fully in FIG. 2.

The transaction processing system 110 includes a transaction processing component 120 that is used to create and revise data, including data that is provided to groupware system 140. As is conventional, the transaction processing component 120 includes a transaction data store 122 and data structure information 124 about the manner in which transaction data is represented in the transaction data store 122. In general, the groupware integration component 130 of the transaction processing system 110 packages portions of the transaction data for transmission to the groupware system 140 in a way that enables the groupware server application 150 to store and present groupware data created and/or revised in the transaction processing component 120, as described more fully below.

In one example, the transaction processing component 120 of the transaction processing system may be a commercial computer application that is developed and licensed (or sold) by a commercial software developer that is different from the business entity that uses the system 100. In another example, the transaction processing component 120 and the groupware integration component 130 may be part of a suite of commercial computer applications that are developed and licensed (or sold) by a commercial software developer for use by multiple, different business entities. For example, the transaction processing component 120 may be a sales application that is used by a sales person or other type of user to create and revise sales order data and, in which case, the sales order data is stored in the transaction data store 122. The sales application may be, for example, a call center software application in which a sales agent enters sales order while talking to a customer on a telephone. Another example of a sales application is a customer relationship management (CRM) application. The transaction processing component 120 may be other types of processing applications, such as an inventory application that provides supply chain and inventory management, a human resource application that performs human resource management functions, and a financial application that performs financial management functions. In some implementations, a data analysis component (such as a business warehouse or other type of data warehouse and associated executable instructions) may be used as the source of a groupware data item sent to the groupware system 140 in addition to, or in lieu of, the transaction processing component 120.

The transaction data store 122 stores data created, revised by, and/or used by the transaction processing component 120. The transaction data store 122 may be, for example, a relational database that logically organizes data into a series of database tables, each of which, in turn, arranges data in a series of columns (where each column represents an attribute stored by the database table) and rows (where each row represents attribute values for an entity). The transaction data store 122 also may be, for example, an object-oriented database that logically or physically organizes data into a series of objects. Each object may be associated with a series of attributes, and each instance of an object may be associated with a series of attribute values. The transaction data store 122 also may be a type of data management system that does not necessarily a relational or object database. For example, a series of XML (Extensible Mark-up Language) files or documents may be used, where each XML file or document includes attributes and attribute values. The data structure information 124 of the transaction processing component 120 may be a data schema or other type of data representation of the data structure used by some, or all of, the transaction data store 122. In some implementations, such as when XML files are used, the data structure information 124 may be stored in the same container (e.g., a file or a document) that stores the transaction data attribute values.

As is conventional, the groupware integration component 130 is configured to package a portion of the transaction data in the transaction data store 122 as a groupware data item for transmission to the groupware system 140. A groupware data item typically relates to a function of the groupware server application 150 running on the groupware system 140. Examples of groupware functions include the maintenance of a calendar of appointments and meetings for a user or other entity, a task or “to do” list for a user or other entity, or an address book or contact list for a user or other entity. Examples of groupware data items include items that represent, for example, information about a contact, information about an activity or task, and information about a calendar appointment, which may be created or revised by the transaction processing component 120.

The groupware integration component 130 of the transaction processing system 110 includes instructions 132 for enabling a person to define an interactive form template that identifies application attributes included in the transaction data 122 that are not otherwise included in standard groupware data of the groupware server application 150. One example of an interactive form is an electronic document created in a Portable Document Format (“PDF”) format and using one of the Adobe® Acrobat products available from Adobe of San Jose, Calif. The interactive form template defined by a person and stored in an interactive form template store 134 for later retrieval and use to create an instance of an interactive form with attribute values from the transaction data store 122.

In some implementations, the interactive form template store 134 of the groupware integration component 130 also may store instances of the interactive form where an instance is populated with attribute values for the attributes included in the interactive form. The stored instances of the interactive forms may be used, for example, to identify whether data received from the groupware server application 150 needs to be used to update the transaction data store 122 with information created and/or revised using the groupware server application 150, as discussed more fully later.

The groupware integration component 130 also includes instructions 136 for creating an attachment for the groupware data item where the attachment is an instance of the interactive form to be provided to the groupware system 140. At runtime, when groupware data is created or revised in transaction data 122, the computer system 110 creates a groupware data item to send the created or revised groupware data to the groupware system 140, as is conventional. The computer system 110 also executes instructions 136 to create and populate an instance of the interactive form with attribute values from the transaction data store 122 that correspond to the application attributes defined in the interactive form and are not otherwise available in the standard groupware server application 150. The computer system 110 sends the instance of the interactive form to the groupware system 140 as an attachment to a groupware data item that includes standard groupware data that corresponds to attributes that are included in the standard groupware server application 150.

The groupware server application 150 includes groupware data 152, such as contact data items 152A, task or activity data items 152B and calendar data items 152C. Examples of a groupware server application 250 include a Microsoft Exchange server and a Lotus Domino server. The groupware server application 150 also includes instructions 157 for updating groupware data items with the received groupware data item. Thus, the groupware server application 150 is configured to receive and store the groupware data item, including the attached interactive form with attributes that are not otherwise available in the groupware server application 150. A person using the groupware server application 150 is able to view the additional attribute values from the transaction application that are included in the interactive form. In some implementations, a person may use a groupware client application operating on a desktop or personal computer (or other type of general-purpose computing device) to access groupware data 152 in the groupware server application 150. In one example, a person may use Microsoft Outlook as a groupware client application to access groupware data on a Microsoft Exchange server (that is, a groupware application server). In another example, a person may use Lotus Notes as a groupware client application to access groupware data on a Lotus Domino server (that is, a groupware application server).

In some implementations, a user of the groupware server application 150 also may be able to edit the attribute values for subsequent transmission to the transaction processing system 110. In this manner, attribute values from the transaction processing component 120 are made available in a groupware server application 150 that are not otherwise included in the groupware product.

For example, a transaction processing component 120 may be a sales application that includes information about sales representatives and territories for which each sales representation is responsible. In such a case, the groupware integration component 130 may attach an instance of interactive form that includes an attribute value of a sales representative identification number and attribute value or values describing the sales territory associated with the sales representative to a contact item for the sales representation that is provided to the groupware application. A user of the groupware server application may access the contact information for the sales representation in the groupware application and display the attachment to view the sales representative identification number and sales territory for which the sales representative is responsible.

As illustrated in the example of the enterprise IT system 100, the transaction processing component 120 and the groupware integration component 130 are operated on one computer system (here, computer system 110), while a different computer system 140 operates the groupware server application 150. As such, the transaction processing component 120 and the groupware integration component 130 are both logically decoupled and physically decoupled from the groupware server application 150, though this need not necessarily be the case. For example, all of the transaction processing component 120, the groupware integration component 130 and the groupware server application 150 may reside on a single computer system, or, alternatively, each may reside on a separate computer system.

In the implementation shown in enterprise IT system 100 or other implementations, the groupware integration component 130 (or aspects thereof) may be included as part of an application program on the enterprise IT system 100 that is separate from a transaction or analytical processing application that is used to create or revise groupware data that is provided to the groupware server application 150. In yet another example, the groupware integration component 130 (or aspects thereof) may be included as part of the groupware server application 150.

Referring to FIG. 2, an enterprise IT system 200 is another example of a computer system 210 with a transaction processing component 220 and a groupware integration component 230 that are both logically decoupled and physically decoupled from a groupware system 240 operating a groupware server application 250. For brevity, the structure and arrangement of FIG. 2 is based on the structure and arrangement of FIG. 1. As would be recognized by one skilled in the art, however, the components and processes of FIG. 2 need not be the same as those described with respect to FIG. 1, nor are the techniques described with respect to FIG. 2 limited to being performed by the structure and arrangement illustrated by FIG. 2.

More particularly, the CRM system 210 is a computer system operating a CRM application 220 having a CRM data store 222 related to the CRM application and information 224 about the structure used to represent data in the CRM data store 222. The CRM data store 222 may a relational database, an object-oriented database, or another type of data collection, or a combination thereof.

The CRM system 210 also includes a groupware integration component 230 having a groupware adapter 232 and a groupware integration repository 234. The groupware adapter 232 is configured to transform groupware data created or revised using the CRM application 220 and stored in the CRM data store 222 to a groupware data item in an intermediate groupware format, such as a groupware format specified by the Internet Engineering Task Force (IETF). For example, the groupware adapter 232 may access an entry, in the CRM data store 222, that relates to a contact, a task or activity or a calendar appointment and transform the entry into a data structure based on an intermediate groupware format. Examples of such intermediate groupware formats include vCard for representing groupware contact information and iCalendar for representing groupware calendar information.

The groupware adapter 232 also is configured to use information in the groupware integration repository 234 to create an instance of an interactive form based on attribute values in CRM data 222 that correspond to the groupware data item. To do so, the groupware adapter 232 selects one of the interactive form templates 234A that corresponds to the type of groupware data (such as a calendar appointment, a contact, or a task or activity item) to be sent to the groupware server application 250. The groupware adapter 232 also identifies an entry in mapping information 234B that maps the form fields used in the selected interactive form template to portions of the CRM data structure information 224. For example, the groupware adapter 232 may identify an attribute in the CRM data structure information 224 that corresponds to a form field in the interactive form template. In one example, a contact sales number field in the interactive form template may be mapped to a particular database table colum in CRM data structure information 224 that stores contact sales numbers for sales representatives. Based on the mapping between fields in the interactive form template and the CRM data structure, the groupware adapter 232 identifies attribute values in CRM data store 222 that correspond to the attributes included in the interactive form template and populates an instance of the interactive form template with the attribute values.

The groupware adapter 232 is configured to store the created interactive form instance as an entry in interactive form instances 234C. The groupware adapter 232 also is configured to send the groupware data item 215 with the interactive form instance as an attachment to a groupware connector 236 operating on the groupware system 240.

Turning now to the groupware system 240, the groupware connector 236, in general, functions as a bridge between a CRM groupware adapter 232 in the CRM computer system 210 and the groupware server application 250. The groupware connector 236 receives the message from the groupware adapter 232 and transforms the groupware data item 215 from the intermediate groupware format to a format that is understandable by groupware server application 250. For example, if the groupware server application 250 is a Microsoft Exchange server, the groupware connector 236 transforms the groupware data from a standard form (such as iCalendar or vCard) to a format used by a Microsoft Exchange server. Similarly, if the groupware server application 250 is a Lotus Domino server, the groupware connector 236 transforms the groupware data into a format readable by a Lotus Domino server. In any case, the interactive form instance that is attached to the groupware data item continues to be associated with the transformed groupware data item. The groupware connector 236 then sends the transformed groupware data and the interactive form instance attachment to groupware server application 250 that includes groupware data 252 and groupware application instructions 255. The groupware server application 250 receives the transformed groupware data and updates the groupware data 252. The groupware data 252 includes contact data 252A, task/activity data 252B, and calendar data 252C. In one example, the groupware server 240 may insert, for example, groupware information relating to a new contact into a groupware address book or contact list. In another example, the groupware server application 250 may insert a new task and/or a new appointment based on the transformed data received.

In some implementations, the groupware server application 250 may send an acknowledgement message to the CRM system 210 through the groupware connector 236 and the groupware adapter 232. Alternatively or additionally, the groupware connector 236 may send an acknowledge message.

In some implementations, a groupware item 265 with an attached interactive form that includes attribute values changed using the groupware server application 250 may be provided to the CRM computer system 210. The groupware adapter 232 may identify attribute values that have been changed by comparing the received interactive form with a copy of the attached interactive form provided with the groupware item 215. The groupware adapter 232 then may provide the changed data to the CRM application 220 in a format understandable to the CRM application 220, as described more fully later.

In some implementations, a groupware adapter 232 may transform the received CRM data into a format understandable to the groupware server 240. In such a case, the groupware connector 236 may not be necessary.

In some cases, the groupware connector 236 may update the groupware data 252 of the groupware server application 250 with the received groupware item 215. To do so, for example, when the groupware connector 236 is stored on a different computer system than the groupware system 240, the groupware connector 236 may use a remote procedure call or other type of protocol that allows a program on one computer system to execute a program on a different computer system.

In some implementations, the groupware connector 236 may be located on the groupware system 240 and may communicate with the groupware adapter 232 through the use of a transfer protocol, such as the Simple Object Access Protocol (SOAP) protocol over the HTTP protocol.

In some implementations, the CRM system 210 also may include middleware that is a set of executable instructions to direct data exchange messages between the computer system 210 and the groupware system 240. The middleware may use different types of message structures to communicate different data structures. Messages containing groupware data may be transferred asynchronously from the computer system 210 and to the groupware system 240. The messages may be exchanged using a messaging system (that is, middleware) using store-and-forward message transfer. The middleware may include a messaging hub that is used to interconnect more than two computer systems or computer applications.

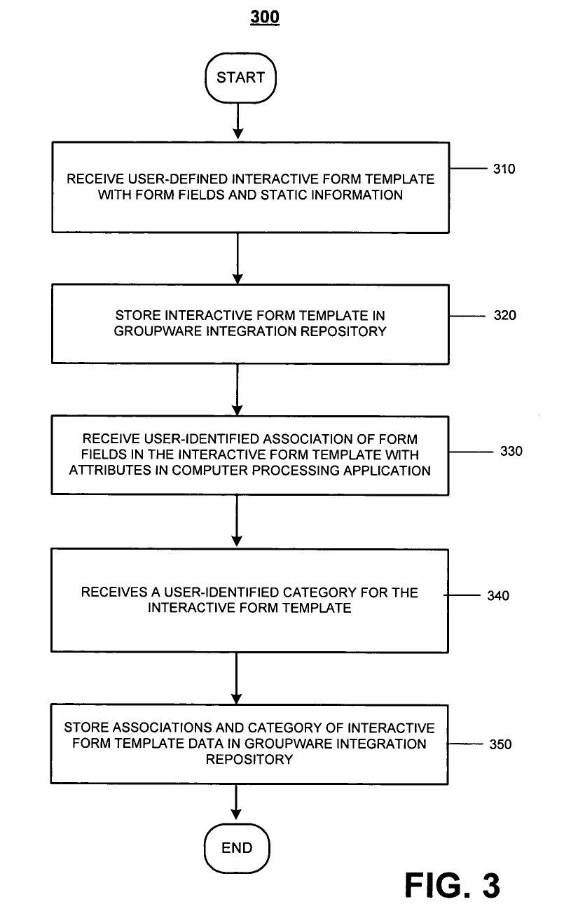

FIG. 3 depicts a process 300 for defining an interactive form and mapping attributes included in the interactive form to attributes included in a computer processing application. The process 300 may be performed by one or more processors in a system, such as, for example, the system 100 of FIG. 1 or the system 200 of FIG. 2. The processor is directed by a method, script, or other type of computer program that includes executable instructions for performing the process 300. Examples of such a collection of executable instructions include the instructions 124 of FIG. 1 to define an interactive form template. The process 300 may be manually initiated by a business analyst, a system administrator or another type of user who desires to define an interactive form template for later use to create instances of interactive forms to attach to groupware data items sent to a groupware application. The groupware application may be, for example, an implementation of the groupware server application 150 in FIG. 1 or the groupware server application 250 in FIG. 2. However, the groupware application need not necessarily be a server-based groupware application.

The process 300 begins when a user manually initiates the process 300, and the processor receives a user-defined interactive form template that identifies form fields and information (such as field labels) or graphics to be included in each instance of the interactive form template (step 310). For example, a user may begin by accessing a user interface displayed on a computer system that enables a user to create or revise an interactive form template. The user identifies form fields to be included in an interactive form template where a form field corresponds to an attribute included in the computer processing application. In one example, the user may identify a first form field and a second form field to contain attributes from the computer processing application. The user also identifies static form information, such as labels for the form fields and other text, images or graphics to be displayed in each instance of the interactive form. The information identified by the user is received by the processor (step 310) and stored in persistent storage as an interactive form template (step 320). The person performing the form design may design the interactive form template in such a way to mimic the look-and-feel (that is, the user interface format and/or design) of the groupware application and/or the transaction processing component 120.

The processor receives a user-identified association of form fields in the interactive form template with a corresponding attribute in the computer processing application (step 330). This may be accomplished, for example, based on user input. In such a case, for example, the processor may present a list of form fields included in the interactive form template and may also present a list of attributes included in the computer processing application. A user may select a particular form field from the list of field forms and a particular attribute from the list of attributes included in the computer processing application with which the particular form field is to be associated. For example, a user may use a pointing device to drag-and-drop one or more form fields onto one or more attributes listed in the computer processing application, or vice versa. In some implementations, the attributes and/or the field forms may be displayed in a hierarchical display from which the user selects. The user may continue identifying associations between form fields and attributes in the computer processing data until all of the form fields in the interactive form template have been associated with one or more attributes in the computer processing data.

The processor also receives a user-identified category for the interactive form template (step 340). This may be accomplished by receiving a user-selected indication of a category that descriptively associates a group of interactive form templates. For example, a category may corresponds to a type of groupware data, such as a contact, an activity or task, or a calendar item. The category of an interactive form template may be used at runtime to identify a particular interactive form template to instantiate as an interactive form instance with attribute values from the computer processing application and send, along with standard groupware data item data (such as a vCard item or an iCalendar item) to a groupware application. In another example, a category may be a data type (or an object type) included in the computer processing application. For example, a category may reflect a business partner category, a sales activity category, or a sales opportunity category. In some cases, the categories of data types used in the computer processing application may be the same as, or similar to, the category of groupware data. In some implementations, more than one category may be used, including a category that identifies a category of data in the computer processing application and a different category that identifies a category of groupware data. Alternatively or additionally, a category may be mapped to a type of data in the computer processing application and/or a type of groupware data.

The processor then stores the associations of form fields to attributes of the computer processing application for later use in creating an interactive form instance to be sent to a groupware application (step 350). For example, the processor may store the association in a groupware integration repository or other type of data collection. An association also may be referred to as a relationship or a mapping between the particular form field in the form instance template and a particular attribute in data for the computer processing application. The stored associations may be referred to as mapping information. The processor also stores the category associated with the interactive form template, for example, in the groupware integration repository (step 350).

In the example of process 300, the association or mapping of each of the form fields to the attribute in the transaction application data is performed after the interactive form template is stored in the groupware integration repository. This may facilitate the use of a commercial product, such as an Adobe® Acrobat® product, to define an interactive form template. The association of the form fields to attributes of the computer processing application may be performed using a specialized tool, such as may be available from a commercial software developer of the computer processing application, a third-party that offers a so-called “add-on tool” to the computer processing application, or a developer of a proprietary computer application developed for a particular business enterprise.

In some implementations, the interactive form template may include mapping information that associates a form field with an attribute in the computer processing application. For example, the interactive form template may be implemented as an XML file and may store, in the interactive form template, a schema (or other type of data structure information) that maps the form fields to the attributes.

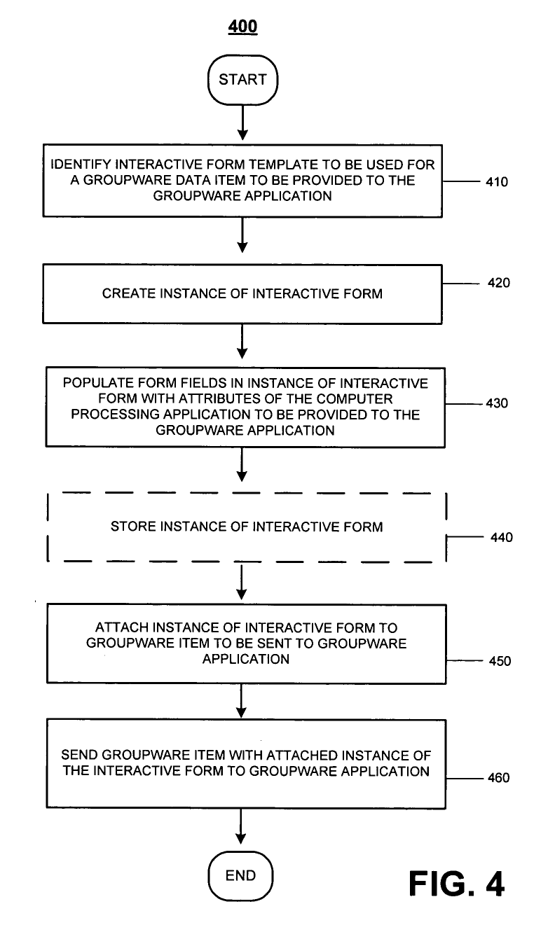

FIG. 4 depicts a process 400 for creating an attachment with attribute values from the computer processing application based on an interactive form template and mapping information of form fields to attributes in the computer processing application. The process 400 may be performed by one or more processors in a system, such as, for example, the transaction processing system 110 in FIG. 1 or the CRM system 200 in FIG. 2. The processor is directed by a method, script, or other type of computer program that includes executable instructions for performing the process 400. Examples of such a collection of executable instructions include the instructions 136 for creating an attachment for a groupware data item in FIG. 1 and the groupware adapter 232 in FIG. 2.

The process 400 may be programmatically initiated when groupware data in a computer processing application has been created or revised. For example, a data change made in a computer processing application may be sent to a middleware component that provides a message having the changed data to a groupware adapter. In a more particular example, information about a business partner may be added to the computer processing application. The added business partner information is provided to a middleware component, which, in turn, provides it to the groupware adapter. As a result of receiving the business partner information, the groupware adapter may format the business partner information as a contact to be provided to the groupware application, after which, the process 400 may be begin.

The processor identifies an interactive form template to be used for a groupware data item to be provided to the groupware server application (step 410). This may be accomplished, for example, by identifying a category associated with an interactive form template that corresponds to the type of data to be provided to the groupware server application. In one example, the processor may receive a groupware data item, such as a vCard item containing information about a business partner or iCalendar item with information about a calendar appointment, to be provided to the groupware application. Based on the type of data received (that is, for example, based on a business partner, a contact, a vCard, an calendar appointment or a iCalendar), an interactive form template for a corresponding category (that is, for example, a contact category or a calendar category) is selected. In another example, the processor may receive a message that includes data from a computer processing application to be provided to a groupware server application. The data in the message need not necessarily be in the form of a groupware data item. Instead, for example, the data in the message may be formatted using a data format understandable to a middleware messaging system used by the computer processing application. In such a case, the processor may create a groupware data item (such as a vCard or iCalendar item) based on the data from the computer processing application.

The processor then creates an instance of the interactive form based on the interactive form template previously identified (step 420) and populates the instance with attributes from the computer processing application based on the mapping information associated with the interactive form template (step 430). In one example, the processor may use a received groupware data item to identify an entry of a particular data type and search for attribute values associated with the entry based on the mapping information. In a more particular example, a processor may receive a business partner or contact groupware data item for a contact identified by a particular name. The processor may search for the particular name in a database table for computer processing application that stores business partner names. Based on the identification of the particular name in the business partner database table (or multiple database tables) and mapping information that identifies attributes that correspond to form fields in the interactive form, the processor populates form fields in the interactive form instance with attribute values for the entry (that is, row) in the contact-name database table. It is important to note that an attribute identified in the mapping information may include an indication of the location (such as a particular database table or a uniform resource locator) where the attribute is stored in the computer processing application. In some implementations, the mapping information may be stored in association with the template, as may be the case with an XML file. In such a case, the processor may not need to look up the mapping information.

The processor optionally stores the instance of the interactive form, for examlpe, in a groupware integration repository (step 440). The processor attaches the instance of the interactive form to the groupware data item, such as a vCard or an iCalendar, (step 450) and sends the groupware data item with the attached instance of the interactive form to the groupware application (step 460).

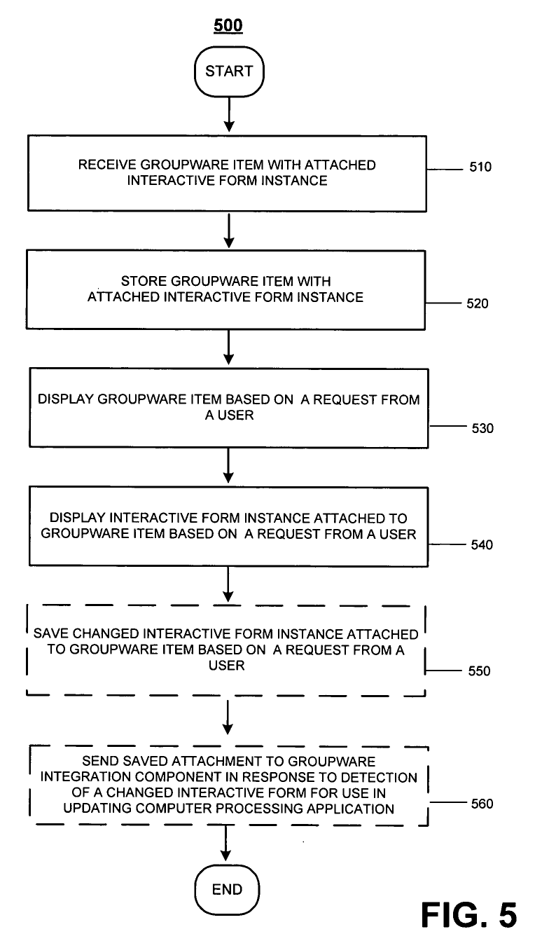

FIG. 5 depicts a process 500 for receiving and enabling a user to access a groupware data item and an interactive form attachment. The process 500 may be performed by one or more processors in a system, such as, for example, the groupware system 140 of FIG. 1 or 240 of FIG. 2. The processor is directed by a method, script, or other type of computer program that includes executable instructions for performing the process 500. For example, the process 500 may be included as instructions of the groupware connector 236 of the groupware system 240. The process 500 may be programmatically initiated when a groupware data item has been received by the groupware system 240. For example, the process 500 may be initiated when the a groupware connector or other component on a system operating a groupware application receives a groupware data item. The groupware application may be, for example, an implementation of the groupware server application 150 in FIG. 1 or the groupware server application 250 in FIG. 2. However, the groupware application need not necessarily be a server-based groupware application.

The processor receives a groupware data item with an attached instance of an interactive form (step 510) and stores the groupware data item with the attached instance of an interactive form (step 520). In one example, the processor may insert, for example, a groupware data item (with its interactive form attachment) relating to a new contact into a groupware address book or contact list in the groupware application. In another example, the processor also may insert a new task and/or a new appointment. In some cases, such as when an appointment identifies multiple people as attendees and one person as the appointment organizer, the processor may store the groupware data item in the calendar of the person identified as organizing the appointment and a meeting request is sent to the mailbox of all other participants.

Subsequently, when a user of the groupware application indicates that the groupware data item is to be displayed, the processor does so (step 530). The processor also displays the instance of interactive form attached to the displayed groupware data item based on a request from the user (step 540). For example, as is conventional, a user may use the groupware application to display a contact, an appointment, or a task that includes an indication of an attachment. As such, a groupware application may be used to display an instance of interactive form with attribute values from the computer processing application and, thereby, enable a person to view attribute values that are otherwise unavailable in the groupware application. In some implementations, the groupware application used by a user to access the groupware data item may be a client application for a groupware server application that received the groupware data item. For example, if the groupware server application is a version of the Microsoft Exchange server, a user may use a version of Microsoft Outlook to display the groupware data item and instance of interactive form attached to the displayed groupware data item.

In some implementations, a user is permitted to edit some or all of the attribute values displayed in the instance of the interactive form. In such a case, the processor saves the changed instance of the interactive form for use in updating the computer processing application (step 550). For example, the processor may send the changed instance of the interactive form to an integration groupware component, such as the groupware integration component 130 in FIG. 1 or groupware adapter 232 in FIG. 2, for use in updating the computer processing data with the changed attribute values in the instance interactive form. This may be accomplished using middleware to identify the changed attribute value and to send an appropriate message with the changes to the computer processing application, which, in turn, updates the computer processing application data. The processor then ends the process 500.

In some implementations, a process for receiving and enabling a user to access a groupware data item and an interactive form attachment also may include transforming the received groupware data item into a different format. For example, the received groupware data item may be transformed from a standard format (such as vCard or iCalendar) into a proprietary format used by a groupware application.

Additionally or alternatively, a processor of a groupware system may monitor the group application and/or groupware server environment to identify a changed instance of an interactive form attached to a groupware data item. When a changed instance is detected, the processor then sends the changed instance interactive form to a groupware integration component or the computer processing application for use in updating the computer processing data with the changed attribute values from the instance interactive form.

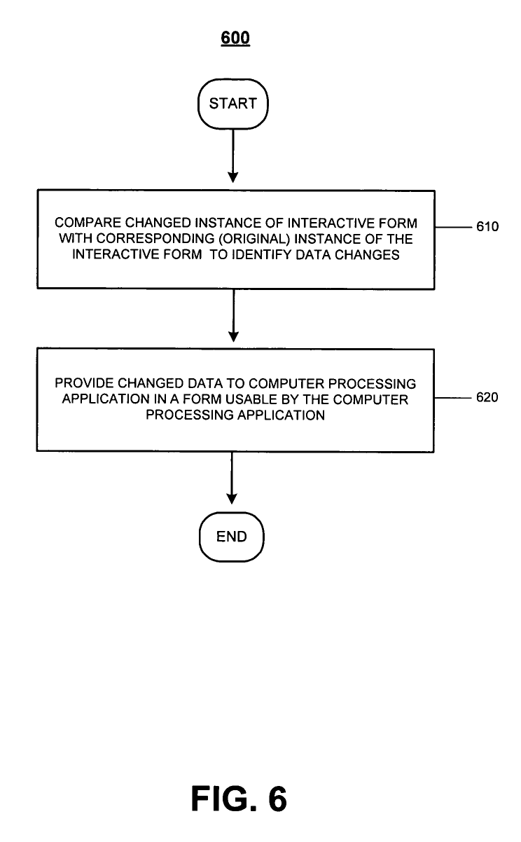

Referring also to FIG. 6, a process 600 updates attributes values of the computer processing application based on attribute values changes made to an instance of an interactive form. The process may be executed by a processor, for example, of the computer processing system 110 in FIG. 1 or the CRM system 210 in FIG. 2.

The processor compares the changed instance of the interactive form with the corresponding instance of the interactive form stored in the groupware integration reposition (step 610). The processor then provides the changed attribute values to the computer processing application, which, in turn, updates the transaction data store of the computer processing application (step 620). To do so, mapping information of interactive form fields to attributes in the computer processing application may be used to identify the attributes in the computer processing application to be changed. Additionally or alternatively, middleware may be used to perform, enable, or facilitate the process 600.

In some implementations, a user may create an instance of an interactive form template and enter attribute values in the instance of the interactive form. The instance may be provided to a groupware integration component, which, uses mapping information that associates each form field with attributes in the computer processing application to provide the attribute values in a form usable by the computer processing application.

The invention can be implemented in digital electronic circuitry, or in computer hardware, firmware, software, or in combinations of them. The invention can be implemented as a computer program product, i.e., a computer program tangibly embodied in an information carrier, e.g., in a machine-readable storage device or in a propagated signal, for execution by, or to control the operation of, data processing apparatus, e.g., a programmable processor, a computer, or multiple computers. A computer program can be written in any form of programming language, including compiled or interpreted languages, and it can be deployed in any form, including as a stand-alone program or as a module, component, subroutine, or other unit suitable for use in a computing environment. A computer program can be deployed to be executed on one computer or on multiple computers at one site or distributed across multiple sites and interconnected by a communication network.

Method steps of the invention can be performed by one or more programmable processors executing a computer program to perform functions of the invention by operating on input data and generating output. Method steps can also be performed by, and apparatus of the invention can be implemented as, special purpose logic circuitry, e.g., an FPGA (field programmable gate array) or an ASIC (application-specific integrated circuit).

Processors suitable for the execution of a computer program include, by way of example, both general and special purpose microprocessors, and any one or more processors of any kind of digital computer. Generally, a processor will receive instructions and data from a read-only memory or a random access memory or both. The essential elements of a computer are a processor for executing instructions and one or more memory devices for storing instructions and data. Generally, a computer will also include, or be operatively coupled to receive data from or transfer data to, or both, one or more mass storage devices for storing data, such as, magnetic, magneto-optical disks, or optical disks. Information carriers suitable for embodying computer program instructions and data include all forms of non-volatile memory, including by way of example semiconductor memory devices, such as, EPROM, EEPROM, and flash memory devices; magnetic disks, such as, internal hard disks or removable disks; magneto-optical disks; and CD-ROM and DVD-ROM disks. The processor and the memory can be supplemented by, or incorporated in special purpose logic circuitry.

A number of implementations of the invention have been described. Nevertheless, it will be understood that various modifications may be made without departing from the spirit and scope of the invention. Accordingly, other implementations are within the scope of the following claims.

What is claimed is:

1. A computer program product tangibly embodied in an information carrier, the computer program product including instructions that, when executed, cause an groupware integration component to perform operations comprising:
generating an instance of an interactive form that corresponds to an interactive form template wherein a form field of the instance of the interactive form includes an attribute value included in a computer processing application;
attaching the instance of the interactive form to a groupware data item to be provided to groupware computer application wherein the groupware data item includes data created or revised by the computer processing application; and
providing the groupware data item and the attached instance of the interactive form to the groupware computer application.

2. The computer program product of claim 1 wherein the instructions, when executed, further cause the groupware integration component to perform operations comprising identifying the interactive form template based on groupware data to be provided by the computer processing application to the groupware computer application.

3. The computer program product of claim 2 wherein identifying the interactive form template based on the groupware data comprises identifying the interactive form template based on a type of data included in the groupware data to be provided by the computer processing application to the groupware computer application.

4. The computer program product of claim 1 wherein providing the groupware data item and the attachment to the groupware computer application comprises transmitting the groupware data item and the attachment to the groupware computer application.

5. The computer program product of claim 1 wherein the instructions, when executed, further cause the groupware integration component to perform operations comprising using mapping information associated with the interactive form template to create the instance of the interactive form.

6. The computer program product of claim 5 wherein the mapping information comprises mapping information that associates a form field with an attribute included in the computer processing application.

7. The computer program product of claim 5 wherein the interactive form template includes the mapping information.

8. The computer program product of claim 5 wherein the mapping information is accessed separately from the interactive form template.

9. The computer program product of claim 1 wherein the groupware computer application comprises a commercial groupware computer application developed for use by multiple business enterprises.

10. The computer program product of claim 1 wherein the instructions, when executed, further cause the groupware integration component to perform operations comprising enabling a person using the groupware computer application to view the attached instance of the interactive form.

11. The computer program product of claim 1 wherein the instructions, when executed, further cause the groupware integration component to perform operations comprising transforming groupware data received from the computer processing application to a format commonly used for groupware data.

12. The computer program product of claim 1 wherein the instructions, when executed, further cause the groupware integration component to perform operations comprising transforming groupware data in the format commonly used for groupware data to a format used by the groupware computer application.

13. The computer program product of claim 1 wherein the computer processing application comprises a transaction processing computer application.

14. The computer program product of claim 1 wherein the computer processing application comprises an analytical computer application.

15. A method for providing data to a groupware computer application, the method comprising:
generating an instance of an interactive form that corresponds to an interactive form template wherein a form field of the instance of the interactive form includes an attribute value included in a computer processing application;
attaching the instance of the interactive form to a groupware data item to be provided to groupware computer application wherein the groupware data item includes data created or revised by the computer processing application; and
providing the groupware data item and the attached instance of the interactive form to the groupware computer application.

16. The method of claim 15 further comprising identifying the interactive form template based on groupware data to be provided by the computer processing application to the groupware computer application.

17. The method of claim 16 wherein identifying the interactive form template based on the groupware data comprises identifying the interactive form template based on a type of data included in the groupware data to be provided by the computer processing application to the groupware computer application.

18. The method of claim 15 wherein the groupware computer application comprises a commercial groupware computer application developed for use by multiple business enterprises.

19. The method of claim 15 further comprising transforming groupware data received from the computer processing application to a format commonly used for groupware data.

20. The method of claim 15 further comprising transforming groupware data in the format commonly used for groupware data to a format used by the groupware computer application.
